(19) United States
(12) Patent Application Publication
(10) Pub. No.: US 2017/0274575 A1
(43) Pub. Date: Sep. 28, 2017

(54) METHOD AND SYSTEM FOR FABRICATING HOLLOW OBJECTS

(71) Applicant: Flexi Matter Ltd., Meyshar (IL)

(72) Inventors: Yishai MESHORER, Meyshar (IL); Alexander VASILEVSKI, Jerusalem (IL)

(21) Appl. No.: 15/505,991

(22) PCT Filed: Aug. 24, 2015
(86) PCT No.: PCT/IL2015/050847

§ 371 Date: Feb. 23, 2017

Related U.S. Application Data
(60) Provisional application No. 62/041,682, filed on Aug. 26, 2014.
(60) Provisional application No. 62/041,684, filed on Aug. 26, 2014.

(51) Int. Cl. B29C 47/92; G05B 19/4097; B29C 67/00

(52) U.S. Cl. CPC B29C 47/92; B29C 67/0055; G05B 19/4097; B33Y 30/00

(57) ABSTRACT

A method of additive manufacturing of a three-dimensional object is disclosed. The method comprises: extruding contours of a modeling material to form a plurality of layers corresponding to slice data of the object; wherein at least one of the contours is extruded generally horizontally above a three-dimensional region which is devoid of any solid support.

### FIELD AND BACKGROUND OF THE INVENTION

The present invention, in some embodiments thereof, relates to extrusion additive manufacturing and, more particularly, but not exclusively, to a method and system for fabricating hollow objects by extrusion additive manufacturing.

An extrusion-based additive manufacturing system builds a three-dimensional object from a digital representation of the 3D object in a layer-by-layer manner by extruding a flowable modeling material. The modeling material is extruded through an extrusion tip carried by an extrusion head on a support platform in an x-y plane.

The extruded modeling material fuses to previously deposited layer of modeling material, and solidifies when cooled off. After completion of a layer, the extrusion of the material is temporarily ceased, and a vertical relative movement occurs between the support platform and the extrusion tip of a distance equal to the thickness of the layer in a direction away from the support platform, so as to prepare the extrusion tip to initiate making a subsequent layer, until a 3D object resembling the digital representation is formed.

Movement of the extrusion head with respect to the support platform is performed under computer control, in accordance with build data that represents the 3D object. The build data is obtained by initially slicing the digital representation of the 3D object into multiple horizontally sliced layers. Then, for each sliced layer, the host computer generates a build path for depositing modeling material to form the 3D object.

In conventional fabrication of 3D objects by depositing layers of a modeling material, supporting layers or structures are typically built underneath overhanging portions or in cavities of objects under construction, which are not supported by the modeling material itself. A support structure is built utilizing the same deposition techniques by which the modeling material is deposited. The host computer generates additional geometry acting as a support structure for the overhanging or free-space segments of the 3D object being formed. The support material is then deposited from a second nozzle pursuant to the generated geometry during the build process. The support material adheres to the modeling material during fabrication, and is removable from the completed 3D object when the build process is complete.

### SUMMARY OF THE INVENTION

According to an aspect of some embodiments of the present invention there is provided a method of additive manufacturing of a three-dimensional object. The method comprises: extruding contours of a modeling material to form a plurality of layers corresponding to slice data of the object; wherein at least one of the contours is extruded generally horizontally above a three-dimensional region which is devoid of any solid support.

According to an aspect of some embodiments of the present invention there is provided a method of additive manufacturing of a three-dimensional object. The method comprises: extruding from a tip of an extruder contours of a modeling material to form on a supporting platform a plurality of layers corresponding to slice data of the object; and establishing a vertical relative movement between the tip and the supporting platform while the material is extruded. According to some embodiments of the invention at least one of the contours is extruded generally horizontally above a three-dimensional region which is devoid of any solid support.

According to some embodiments of the invention a vertical distance between the tip and the supporting platform increases gradually during the entire extrusion of a contour onto which another contour is to be directly extruded.

According to some embodiments of the invention the vertical relative movement is during extrusion of a contour onto which another contour is to be directly extruded, but only at a vicinity of a starting point and an ending point of the contour.

According to some embodiments of the invention the establishing the vertical movement is executed to form a contour segment having a vertical slope which is less than 45 degrees.

According to some embodiments of the invention the method comprises, for at least one contour, varying a thickness of the contour synchronously with the variation of the vertical movement.

According to some embodiments of the invention a largest horizontal dimension of the three-dimensional region is larger than a characteristic diameter of the contours by a factor of at least 5.

According to some embodiments of the invention a largest horizontal dimension of the three-dimensional region is larger than a characteristic diameter of the contours by a factor of at least 10.

According to some embodiments of the invention the three-dimensional region is internal to the object.

According to some embodiments of the invention the three-dimensional region is external to the object.

According to some embodiments of the invention the at least one contour is supported by at least two vertical walls bordering the three-dimensional region.

According to some embodiments of the invention the at least one contour is supported by only one wall bordering the three-dimensional region.

According to some embodiments of the invention the at least one contour forms a continuous layer which completely covers the three-dimensional region.

According to some embodiments of the invention at least a segment of the at least contour is extruded outwardly from a vertical wall of the object, and above the three-dimensional region, in a manner that the segment is not tangential to any other previously extruded segment.

According to some embodiments of the invention the at least one contour forms a layer which only partially covers the three-dimensional region.

According to some embodiments of the invention the layer has an opening above the three-dimensional region.

According to some embodiments of the invention at least a segment of the at least one contour is extruded horizontally along a spiral path.

According to some embodiments of the invention the object has a curvature along a vertical direction, and wherein for at least a portion of the layers, a number of contours or contour segments forming each layer is varied as a function of a slope of the curvature along the vertical direction.

According to some embodiments of the invention the method comprises, for at least one layer, determining a containment relation between an outermost contour of the layer and an outermost contour of a preceding or a subsequent layer, and selecting an extrusion path for the at least one layer based on the containment relation.

According to some embodiments of the invention the at least one layer has an opening above the three-dimensional region, and the method comprises: determining a locus of intersection between a periphery of the opening and the extrusion path; and updating the extrusion path based on the locus of intersection.

According to some embodiments of the invention the method comprises receiving as a user input a starting point for at least one contour relative to a respective at least one layer, wherein the extrusion of the at least one contour at the respective at least one layer is initiated at the starting point.

According to some embodiments of the invention the method comprises automatically selecting starting points for all contours other than the at least one contour, based on an outline of the three-dimensional object.

According to an aspect of some embodiments of the present invention there is provided a system for additive manufacturing of a three-dimensional object. The system comprises: a supporting platform; a modeling material extruder; and a controller operatively associated with a computer and being configured to receive slide data of the object from the computer and to control the extruder to extrude contours of a modeling material thereby to form on the supporting platform a plurality of layers corresponding to the slice data, wherein at least one of the contours is extruded generally horizontally above a three-dimensional region which is devoid of any solid support.

According to an aspect of some embodiments of the present invention there is provided a system for additive manufacturing of a three-dimensional object. The system comprises: a supporting platform; a modeling material extruder; a drive for establishing relative motion between the modeling material extruder and the supporting platform; and a controller operatively associated with a computer and being configured to receive slide data of the object from the computer and to control the drive and the extruder to extrude contours of a modeling material thereby to form on the supporting platform a plurality of layers corresponding to the slice data, wherein a vertical relative movement between the tip and the supporting platform is established while the material is extruded.

According to some embodiments of the invention the controller is configured to ensure that wherein a vertical distance between the tip and the supporting platform increases gradually during the entire extrusion of a contour onto which another contour is to be directly extruded.

According to some embodiments of the invention the controller is configured to establish the vertical relative movement during extrusion of a contour onto which another contour is to be directly extruded, but only at a vicinity of a starting point and an ending point of the contour.

According to some embodiments of the invention the controller is configured to establish the vertical relative movement so as to form a contour segment having a vertical slope which is less than 45 degrees.

According to some embodiments of the invention the controller is configured to vary a thickness of at least one contour synchronously with the variation of the vertical distance.

According to some embodiments of the invention the three-dimensional region is internal to the object.

According to some embodiments of the invention the three-dimensional region is external to the object.

According to some embodiments of the invention the at least one contour is supported by at least two vertical walls bordering the three-dimensional region.

According to some embodiments of the invention the at least one contour is supported by only one wall bordering the three-dimensional region.

According to some embodiments of the invention the at least one contour forms a continuous layer which completely covers the three-dimensional region.

According to some embodiments of the invention at least a segment of the at least contour is extruded outwardly from a vertical wall of the object, and above the three-dimensional region, in a manner that the segment is not tangential to any other previously extruded segment.

According to some embodiments of the invention the at least one contour forms a layer which only partially covers the three-dimensional region.

According to some embodiments of the invention the layer is continuous.

According to some embodiments of the invention the layer is discontinuous.

According to some embodiments of the invention the layer has an opening above the three-dimensional region.

According to some embodiments of the invention at least a segment of the at least one contour is extruded horizontally along a spiral path.

According to some embodiments of the invention the system comprises the computer.

According to some embodiments of the invention the computer is configured to determine a containment relation between an outermost contour of the layer and an outermost contour of a preceding or a subsequent layer, and to select an extrusion path for the at least one layer based on the containment relation.

According to some embodiments of the invention the at least one layer has an opening above the three-dimensional region, and wherein the computer is configured to determine a locus of intersection between a periphery of the opening and the extrusion path, and to update the extrusion path based on the locus of intersection.

According to some embodiments of the invention the system comprises a user interface configured for receiving as a user input a starting point for at least one contour relative to a respective at least one layer, wherein the extrusion of the at least one contour at the respective at least one layer is initiated at the starting point.

According to an aspect of some embodiments of the present invention there is provided a method of additive manufacturing of a three-dimensional object. The method comprises: receiving as a user input a starting point for at least one contour relative to a respective at least one layer; and extruding contours of a modeling material to form a plurality of layers corresponding to slice data of the object, wherein the extrusion of the at least one contour at the respective at least one layer is initiated at the starting point.

According to some embodiments of the invention the method comprises automatically selecting starting points for all contours other than the at least one contour, based on an outline of the three-dimensional object and based on the input starting point.

According to an aspect of some embodiments of the present invention there is provided a system for additive manufacturing of a three-dimensional object. The system comprises: a supporting platform; a modeling material extruder; a controller operatively associated with a computer; and a user interface configured for receiving as a user input a starting point for at least one contour relative to a respective at least one layer; wherein the controller is configured to receive slide data of the object from the computer and to control the extruder to extrude contours of a modeling material thereby to form on the supporting platform a plurality of layers corresponding to the slice data, wherein the extrusion of the at least one contour at the respective at least one layer is initiated at the starting point.

According to some embodiments of the invention the computer is configured to automatically select starting points for all contours other than the at least one contour, based on an outline of the three-dimensional object.

According to an aspect of some embodiments of the present invention there is provided a method of processing a data file for extrusion additive manufacturing. The data file having slice data including three-dimensional contour coordinates defining a plurality of planes corresponding to planar slices of an object. The method comprises, for each of at least some slices: identifying coordinates of outermost contours and coordinates of inner contours with respect to the outermost contours; determining a containment relation between an outermost contour of the slice and an outermost contour of a preceding slice or a subsequent slice; ordering the contours in the slice based on the identification and based on the containment relation, thereby processing the data file; and storing the processed data file in a medium readable by a controller of an extrusion additive manufacturing system.

According to some embodiments of the invention, when: the slice is an intermediate slice and the outermost contour of the slice contains the outermost contour of a subsequent slice; then: the contours are ordered from the outermost contour of the slice to a contour below the outermost contour of the subsequent slice.

According to some embodiments of the invention, when: the slice is an intermediate slice, the coordinates of inner contours are identified and the outermost contour of the slice contains the outermost contour of the subsequent slice; then: the contours are ordered from a contour below the outermost contour of the subsequent slice to an innermost contour of the slice.

According to some embodiments of the invention when: the slice is a non-bottommost slice and the outermost contour of the slice contains the outermost contour of the preceding slice; then: the contours are ordered from a contour above the outermost contour of the preceding slice to the outermost contour of the slice.

According to some embodiments of the invention when: the slice is non-bottommost slice, the coordinates of inner contours are identified and the outermost contour of the slice contains the outermost contour of the preceding slice; then: the contours are ordered from a contour above the outermost contour of the preceding slice to an innermost contour of the slice.

According to an aspect of some embodiments of the present invention there is provided a method of processing a data file for extrusion additive manufacturing, the data file having slice data including three-dimensional contour coordinates. The method comprises: identifying closed planar contours in the data; for each of at least some of the closed contours, updating vertical coordinates of at least a segment of the contour, such that, following the update, the segment is tilted at an angle relative to a plane engaged by the contour prior to the update, thereby processing the data file; and storing the processed data file in a medium readable by a controller of an extrusion additive manufacturing system.

According to some embodiments of the invention the method comprises, for each segment, selecting a point over the contour, and defining the segment as comprising the point and having a predetermined length.

According to some embodiments of the invention the tilt is selected such that the contour connects to a contour engaging another plane being above the plane, thereby defining a contour having a helical shape.

According to some embodiments of the invention the method comprises identifying coordinates of outermost contours and coordinates of inner contours with respect to the outermost contours, wherein the updating the vertical coordinates is based on the identification.

According to some embodiments of the invention the at least a segment of the contour is a plurality of segments and the vertical coordinates are updated to gradually increase along the plurality of segments.

According to some embodiments of the invention the method comprises updating horizontal coordinates of at least one contour engaging a plane, so as to connect an ending point of the contour with a starting point of another contour engaging the plane, thereby providing a combined contour.

According to some embodiments of the invention the combined contour forms a spiral shape in the plane.

According to an aspect of some embodiments of the present invention there is provided a computer software product, comprising a computer-readable medium in which program instructions are stored, which instructions, when read by a data processor, cause the data processor to execute the method as described herein and optionally as further detailed below.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of extrusion additive manufacturing system, according to some embodiments of the present invention;

FIG. 2 is a flowchart diagram of a method suitable for additive manufacturing of a three-dimensional object, according to some embodiments of the present invention;

FIGS. 3A-B are schematic illustrations of an object having an internal cavity at least partially covered by overhanging structures, according to some embodiments of the present invention;

FIGS. 4A-B are schematic illustrations of an object having external overhanging structures, according to some embodiments of the present invention;

FIGS. 5A-C are schematic illustrations of a hollow object in which one or more of its internal cavities is completely closed from all sides, according to some embodiments of the present invention;

FIG. 6 is a schematic illustration of a hollow object in which one or more of its internal cavities is covered by a layer having an opening above the cavity, according to some embodiments of the present invention;

FIG. 7 is a schematic illustration of an object having a curvature along the vertical direction, according to some embodiments of the present invention;

FIG. 8 is a schematic illustration of a layer in which one or more of the contours is extruded horizontally along a spiral path, according to some embodiments of the present invention;

FIGS. 9A-D are schematic illustrations describing a procedure in which a vertical wall is fabricated by extruding a modeling material, while maintaining a continuous or stepwise relative vertical movement, according to some embodiments of the present invention;

FIG. 10 is a schematic illustration describing a procedure in which the vertical distance between the tip of the extruder and the supporting platform is varied only at a vicinity of a starting point and an ending point of the contour, according to some embodiments of the present invention;

FIG. 11 is a schematic illustration of an embodiment in which the thickness of one or more contours is increased synchronously with the vertical relative motion during extrusion;

FIG. 12 is a flowchart diagram of a method suitable for processing a data file for extrusion additive manufacturing, according to some embodiments of the present invention;

FIGS. 13A-I are flowchart diagrams describing a procedure based on a set of criteria for ordering contours according to some embodiments of the present invention;

FIG. 14 is a flowchart diagram of another method suitable for processing a data file for extrusion additive manufacturing, according to some embodiments of the present invention;

FIG. 15 is a flowchart diagram of a method that combines the methods shown in FIGS. 12 and 14, according to some embodiments of the present invention; and

FIG. 16 is a flowchart diagram of an additional method suitable for additive manufacturing of a three-dimensional object, according to some embodiments of the present invention.

### DESCRIPTION OF SPECIFIC EMBODIMENTS OF THE INVENTION

The present invention, in some embodiments thereof, relates to extrusion additive manufacturing and, more particularly, but not exclusively, to a method and system for fabricating hollow objects by extrusion additive manufacturing.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

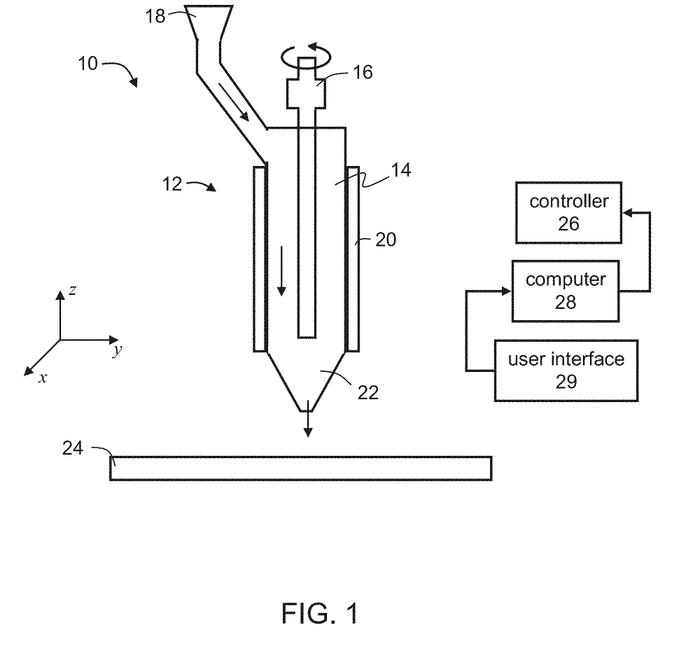

FIG. 1 is a schematic illustration of extrusion additive manufacturing system 10, according to some embodiments of the present invention. System 10 comprises an extruder 12 for extruding contours of modeling material onto a supporting platform 24 or onto previously extruded modeling material contours supported by supporting platform 24.

Extruder 12 can comprise an extrusion barrel 14 for holding the modeling material, a motor-driven rotating screw 16 for forcing the modeling material through extrusion barrel 14, and a hollow tip 22 serving as a nozzle through which the modeling material is extruded onto supporting platform 24 or onto a previously formed extruded layer. System 10 can further comprise a feed hopper 18 for providing modeling material to extruder 12, and a heater 20 for heating the modeling material in extrusion barrel 14.

Extruder 12 is optionally and preferably designed in accordance with the modeling material being extruded.

As used herein, “modeling material” refers to any material that constitutes the final object to be fabricated once all the building and post building operations are completed.

Representative examples of modeling materials that can be extruded by system 10, including, without limitation, a polymeric material, a wax material, a ceramic material, a metal, a metal alloy, composite material, material enforced by a fiber, such as, but not limited to, glass, carbon, wood, metal, and the like. The modeling material can be supplemented with an aqueous or non-aqueous binder and/or an additive such as, but not limited to, a viscosity modifier, a dispersant, and a lubricant. In some embodiments of the present invention extruder 12 extrudes only modeling material, and does not extrude any support material, throughout the fabrication of the object. In some embodiments, system 10 is devoid of any extruder that extrudes support material.

As used herein, “support material” refers to material that is dispensed to support the object being built and that is ultimately separated from the object in a post-build operation.

In various exemplary embodiments of the invention tip 22 of extruder 12 has a diameter of from about 0.3 mm to about 50 mm, or about 0.3 mm to about 5 mm, or from about 20 mm to about 50 mm.

For extruding the modeling material, the material is fed into extrusion barrel 14 where it is melted by heater 20 and pressurized to flow through tip 22 by means of rotating screw 16.

System 10 also comprises a controller 26 operatively associated with a computer 28. In some embodiments of the present invention system 10 further comprises computer 28. Controller 26 receives slide data of an object to be fabricated from computer 28 and controls extruder 12 to extrude contours of the modeling material thereby to form on supporting platform 24 a plurality of layers corresponding to the slice data. Controller 26 can communicate with any of the components of extruder 12 and platform 24 via communication lines (not shown) or wirelessly.

System 10 can also comprise a user interface 29 for allowing the operator to provide various parameters as an input to system 10. For example, the operator can provide a starting point for one or more contours that form the object to be manufactured as further detailed hereinbelow.

Any of extruder 12 and supporting platform 24 can be movable horizontally and/or vertically, so as to establish relative motion between extruder 12 and platform 24, wherein the horizontal motion facilitates the patterning of the individual layers, and the vertical motion facilitates the buildup of the layers on top of each other as known in the art. Thus, for example, in some embodiments extruder 12 is static and supporting platform 24 is movable both horizontally and vertically, in some embodiments extruder 12 is movable both horizontally and vertically and supporting platform 24 is static, in some embodiments both extruder 12 and supporting platform 24 are movable both horizontally and vertically (for example, in opposite directions), in some embodiments extruder 12 is movable horizontally and supporting platform 24 is movable vertically, in some embodiments extruder 12 is movable both horizontally and vertically, and supporting platform 24 is movable only vertically, in some embodiments extruder 12 is movable vertically and supporting platform 24 is movable horizontally, and in some embodiments extruder 12 is movable only vertically and supporting platform 24 is movable both horizontally and vertically. The relative motion between extruder 12 and platform 24 is controlled by controller 26 based on slice data received by controller 26 from computer 28.

The operation of system 10 is based on slice data that is typically received as a data file containing three-dimensional contour coordinates which define a plurality of planes corresponding to planar slices of the object, such that the overall shape of the object is described by the slices. Typically, the data file is in a format that is readable by the controller of the system. Representative examples of computer readable formats suitable for the present embodiments include, without limitation, STL, DWG/DXF, IDEAS, IGES, and VRML. The data file can be processed, preferably by computer 28, wherein the processing may include various operations, including, without limitation, updating of vertical coordinates, updating of horizontal coordinates, ordering and reordering of contours, updating extrusion paths, and the like. Representative examples of processing techniques are described hereinunder.

Once the data file is processed, the slice data are transferred from computer 28 to controller 26, which controls the operation of extruder 12, and optionally also platform 24. Controller 26 signals extruder 12 to extrude the modeling material onto platform 24 and also signals at least one of extruder 12 and platform 24 to move along the vertical and horizontal direction, according to the slice data.

FIG. 1 also shows a three-dimensional Cartesian coordinate system, defining an x direction a y direction and a z direction. Herein, “vertical direction” refers to a direction which is parallel or anti-parallel to the z direction, and a “horizontal direction” refers to any direction parallel to or in the x-y plane.

In some embodiments of the present invention controller 26 and optionally also computer 28 can perform various operations, according to embodiments of the invention. Representative examples of some operations are described below with reference to flowchart diagrams.

While the methods that are described hereinbelow may be used in conjunction with system 10, these methods can be used in conjunction with other extrusion additive manufacturing systems, provided such extrusion additive manufacturing system are configured to execute one or more of the operations of the methods that are described hereinbelow.

It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

Selected operations of the methods described below can be embodied in many forms. For example, they can be embodied in on a tangible medium such as a computer (e.g., computer 28) for performing the method steps. They can be embodied on a computer readable medium, optionally and preferably non-transitory computer readable medium, comprising computer readable instructions for carrying out the operations. They can also be embodied in electronic device having digital computer capabilities arranged to run the computer program on the tangible medium or execute the instruction on a computer readable medium.

Computer programs implementing some of the operations described below can commonly be distributed to users on a distribution medium such as, but not limited to, a CD-ROM or a flash drive, or they can be provided via a communication network, such as, but not limited to, the internet. From the distribution medium, the computer programs can be copied to a hard disk or a similar intermediate storage medium. The computer programs can be run by loading the computer instructions either from their distribution medium or their intermediate storage medium into the execution memory of the computer, configuring the computer to act in accordance with one or more operations of the method of the present embodiments. All these operations are well-known to those skilled in the art of computer systems.

Following is a description of methods suitable for additive manufacturing of a three-dimensional object, according to some embodiments of the present invention.

One or more of the operations described below can be executed by system 10.

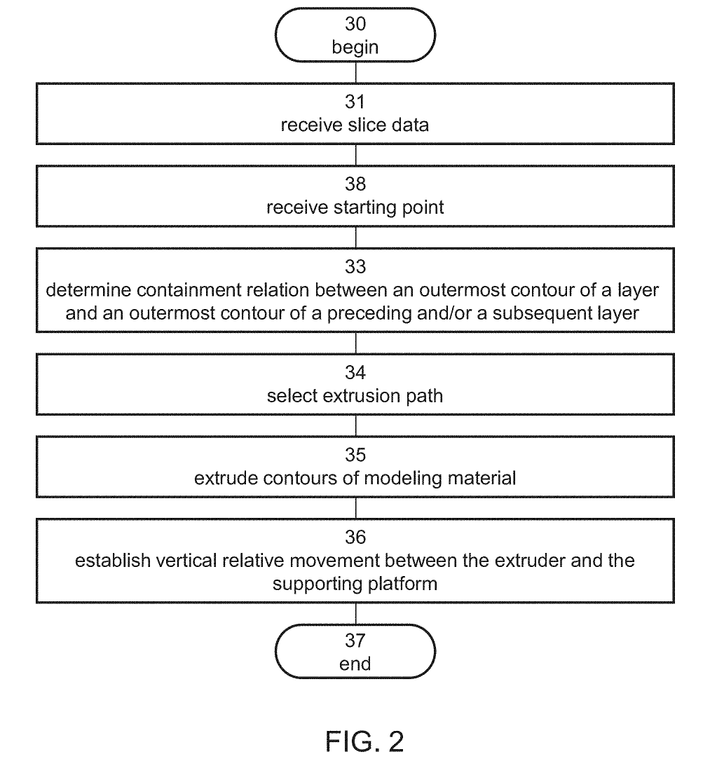

FIG. 2 is a flowchart diagram of a method suitable for additive manufacturing of a three-dimensional object, according to some embodiments of the present invention.

The method begins at 30 and continues to 31 at which slice data are received.

The slice data can be received from a local computer (e.g., computer 28) connected to an extrusion additive manufacturing system, such as, but not limited to, system 10 that is configured for receiving the slice data and executing the method.

Alternatively, the slice data can be received from a remote computer that communicates with the system over a communication network, such as, but not limited to, a local network or the internet.

The method optionally and preferably continues to 33 at which for at least one layer defined by the slice data, a containment relation is determined, within the layer, between an outermost contour of the layer and an outermost contour of a preceding and/or a subsequent layer.

A containment relation is a well known operation in the art of computer aid design. Generally, a contour C₁ is said to contain a contour C₂ if all the points of contour C₂ are in the area enclosed by contour C₁.

In the context of the present embodiments, containment relation is determined between contours of different layers, namely contours engaging different planes. Such a relation can be determined by considering only the horizontal coordinates of the contours without considering their vertical coordinates. This is mathematically equivalent to an operation in which one or both of the contours are projected onto a plane parallel to the contours, such that both contours engage the same plane, wherein the containment relation is determined after the projection.

The present inventors found that such a determination of containment relation is advantageous because it allows manufacturing hollows three-dimensional objects, without using support material.

The method optionally and preferably continues to 34 at which an extrusion path is selected for the respective layer. The selection of the path is based on one or more predetermined criteria. In some embodiments the selection of the path is based on the containment relation determined at 33, and in some embodiments the selection of the path is based one or more other criteria. Representative examples of procedures suitable for selecting the extrusion path are provided hereinunder. Operations 33 and 34 are optionally and preferably executed by a data processor. Alternatively, operations 33 and 34 can be executed by the controller of the system.

The method continues to 35 at which contours of a modeling material are extruded to form a plurality of layers corresponding to the slice data of the object. At least part of the extrusion is executed while there is a horizontal relative motion between the extruder and the supporting platform so as to form the contours.

Preferably, the horizontal relative motion is along a path selected at 34, so that the formed contours are also along that path. In some embodiments of the present invention, only modeling material is extruded, without extruding any support material, throughout the fabrication of the object.

In some optional embodiments of the present invention, which optional embodiments can be employed in combination with any other embodiment described herein, one or more of the contours is extruded generally horizontally above a three-dimensional region which is devoid of any solid support. The size, for example, the largest horizontal dimension, of the three-dimensional region is preferably larger than a characteristic diameter of the contours by a factor of at least 1 or at least 2 or at least 3 or at least 4 or at least 5.

The three-dimensional region can be internal or external to object. When the region is internal, the manufactured object has one or more internal cavities 302 that are generally empty, except from air or other gases that may occupy the cavity, wherein the cavities are at least partially covered by overhanging structures 304.

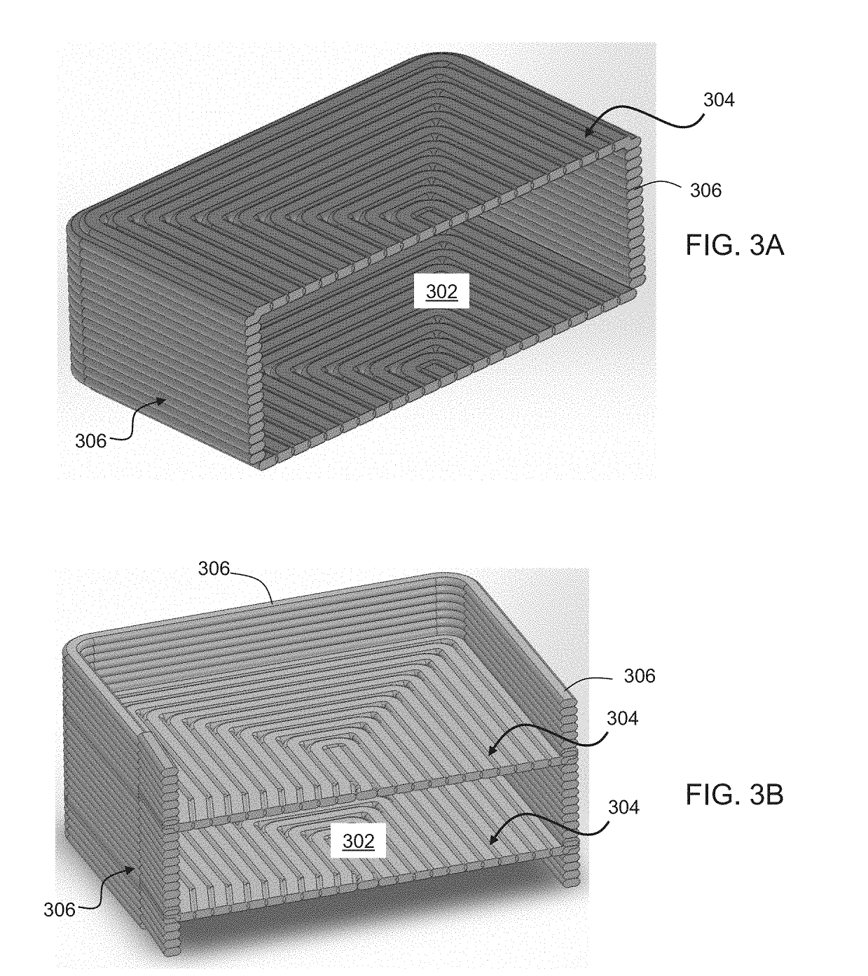

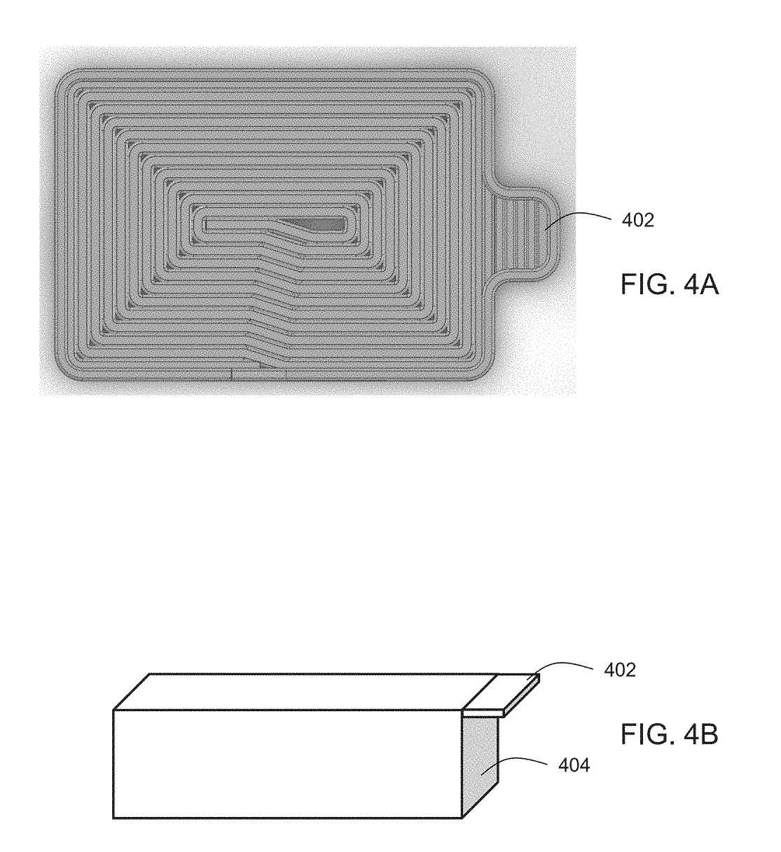

These embodiments are illustrated in FIGS. 3A-B. When the region is external, the manufactured object has one or more overhanging structures, such as shelves or balconies 402 or the like, extending outwardly from one or more of the external walls of the object. These embodiments are illustrated in FIGS. 4A-B. Manufacturing of objects having both types of overhanging structures is also contemplated according to some embodiments of the present invention.

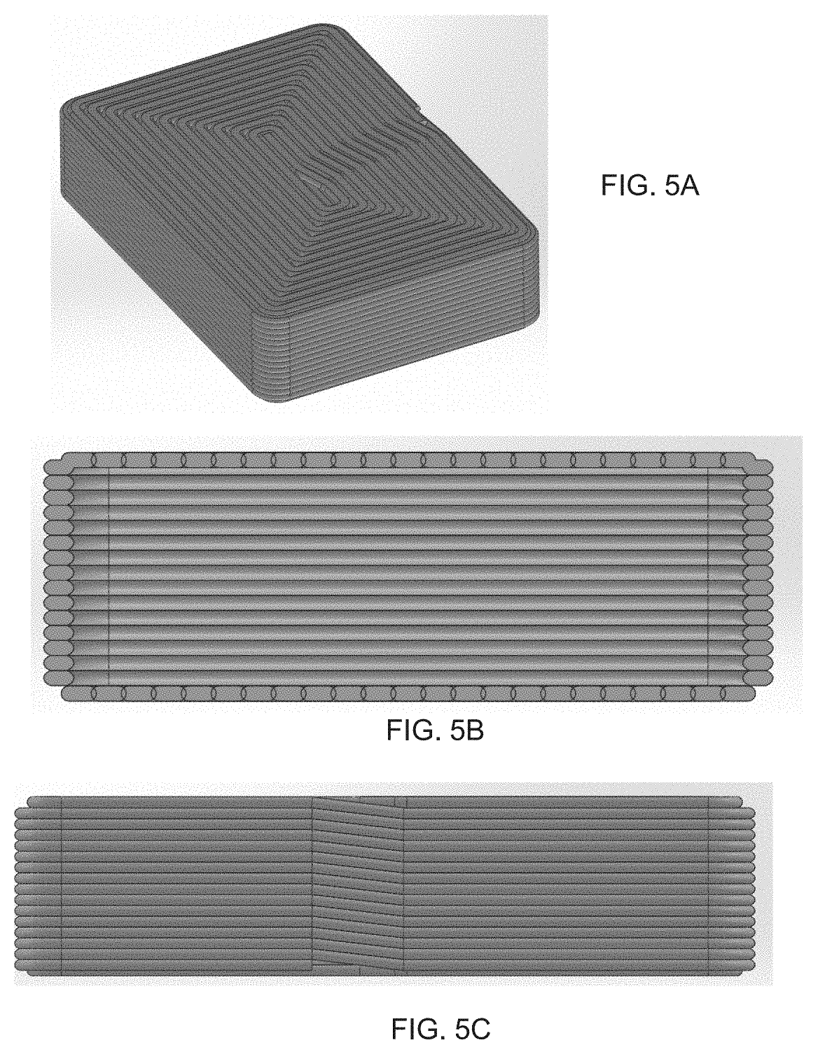

One or more of the contours that are above the three-dimensional region and therefore form the overhanging structures can be supported by at least two vertical walls bordering the three-dimensional region. These embodiments are particularly useful when the three-dimensional region is internal to the object, as illustrated, for example, on FIGS. 3A-B, wherein overhanging contours 304 are supported by walls 306 at opposite sides or surrounding of the internal cavity, but are not supported at any other location within the cavity. The overhanging contours can form a continuous layer which completely covers the three-dimensional region. A representative example of these embodiments is the manufacturing of a hollow object in which one or more of its internal cavities is completely closed from all sides, as schematically illustrated in FIGS. 5A (perspective view) and 5B (cross sectional view) and 5C (side view). It is recognized that it is not possible to manufacture such a hollow objects by conventional techniques which require the use of support material, because it is not possible to remove support material from internal cavities that are closed from all sides.

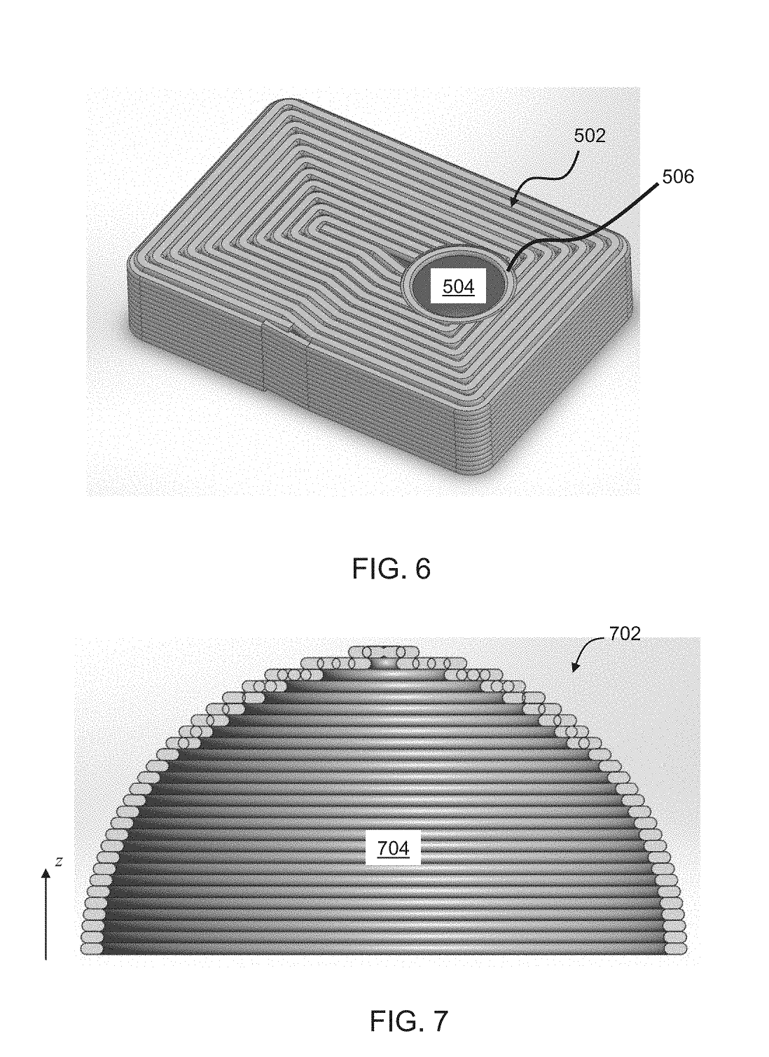

The overhanging contours can also form a continuous or discontinuous layer which only partially covers the three-dimensional region. A representative example of these embodiments is the manufacturing of a hollow object in which one or more of its internal cavities is covered by a layer 502 having an opening 504 above the cavity, as illustrated, for example, in FIG. 6. In some embodiments of the present invention the method determines a locus of intersection between a periphery of the opening and the extrusion path, and updates the extrusion path selected at 34 based on the locus.

Typically, wherever a contour (typically an overhanging contour) intersects the periphery of the opening, its extrusion is terminated. Once all the contours that intersect the periphery are defined, the extrusion path is updated, so as to extrude an additional contour along the locus of intersection. A representative example of a contour along the locus of intersection is illustrated at 506. It is to be understood that it is not necessary to determine the locus of intersection and to update the extrusion path while or after the respective contours are extruded (although such operation is also contemplated). In various exemplary embodiments of the invention both the determination of the locus of intersection and the updating of the extrusion path is executed by a data processor before the extrusion is initiated. For example, a data processor can process the data file, and define and update the extrusion path before uploading the file to the controller of the system.

One or more of the contours that are above the three-dimensional region can alternatively or additionally supported by only one wall bordering the three-dimensional region. These embodiments are particularly useful when the three-dimensional region is external to the object, as illustrated, for example, in FIGS. 4A-B, wherein overhanging contours are supported only by the wall 404 from which the overhanging contours outwardly extend, but are not supported at any other location within the cavity. Such overhanging structures can be manufactured by extruding at least a segment of at least contour outwardly from the vertical wall, and above the three-dimensional region, in a manner that the segment is not tangential to any other previously extruded segment.

For objects having a curvature along the vertical direction, the extrusion is optionally and preferably such that, for at least a portion of the layers, the number of contours or contour segments forming each layer is varied as a function of a slope of the curvature along the vertical direction. A representative example of these embodiments is illustrated in FIG. 7, showing a cross sectional view of a dome 702 that encloses a three-dimensional region 704 from above, wherein the three-dimensional region is devoid of any solid support. As shown, dome 702 has a curvature along the vertical direction, and the number of contours that form each layer vary as a function of the vertical slope. Specifically, the number of contours that form a layer at which the absolute value of the slope is smaller is larger than the number of contours that form a layer at which the absolute value of the slope is greater.

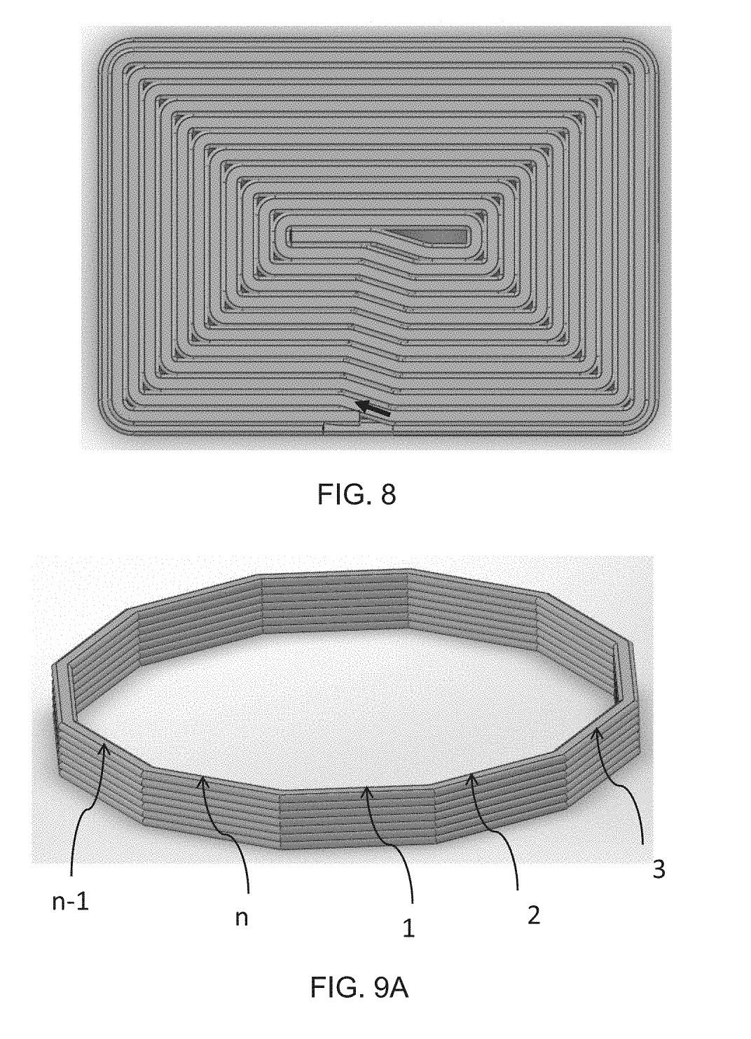

In some optional embodiments of the present invention, which optional embodiments can be employed in combination with any other embodiment described herein, at least a segment of one or more of the contours is extruded horizontally along a spiral path, as illustrated, for example, in FIGS. 4A, 5A, 6 and 8. The advantage of these embodiments is that it allows forming horizontal two-dimensional regions in a continuous manner. When the slice data do not originally include spiral paths, the data file containing the slice data is preferably updated by a data processor before it is being uploaded to the controller of the extrusion additive manufacturing system. This can be done, for example, by selecting a plane corresponding to a slice of the object, identifying coordinates of open contours engaging the plane, and updating the horizontal coordinates of one or more of these open contours so as to connect an ending point of the contour with a starting point of another contour engaging the same plane.

The method optionally and preferably continues to 36 at which a vertical relative movement between the tip of the extruder and the supporting platform is established, while the modeling material is extruded. These embodiments are unlike conventional extrusion-based additive manufacturing systems, in which the extrusion of the material is temporarily ceased before the vertical relative movement between the tip and supporting platform is established. Typically, the vertical relative movement during extrusion is executed on the outermost contours of the respective layer. For example, such vertical relative movement during extrusion can be employed for contours on which other contours are to be directly extruded in a subsequent layer.

The relative movement can occur according to more than one protocol. For example, in some embodiments, the vertical distance between the tip of the extruder and the supporting platform is increased gradually during the entire extrusion of a contour onto a previously extruded contour. These embodiments are particularly useful when manufacturing a vertical wall that surrounds a three-dimensional region which is devoid of any solid material (e.g., when manufacturing an object without extruding a support material). Such a vertical wall can be fabricated by extruding a modeling material contour shaped in accordance with the shape of the respective slice, while maintaining a continuous or stepwise relative vertical movement between the tip and the supporting platform.

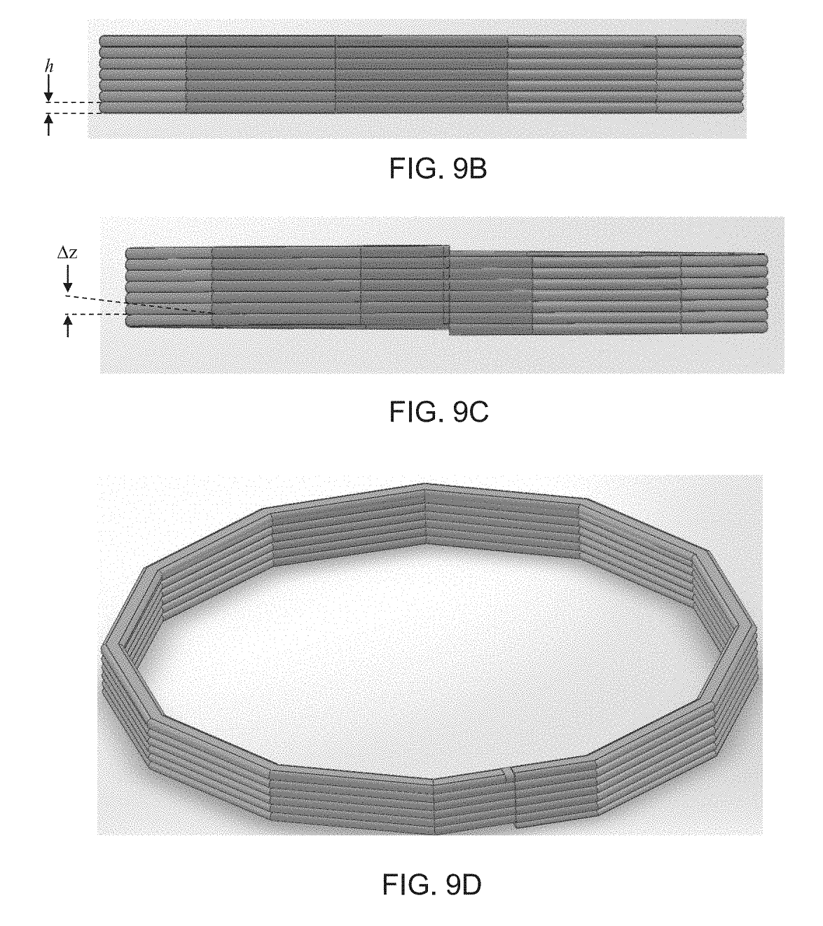

A representative example of such a procedure is schematically illustrated in FIGS. 9A-D. The total number n of segments of the contour for a given slice is determined (FIG. 9A). In the schematic illustration of FIG. 9A, which is not to be considered as limiting, n=12. The thickness h of the layer (FIG. 9B) is then divided by n, to provide a vertical step Δz=h/n. For example, when h=1.5 mm and n=12, Δz=0.125 mm. The vertical distance between the tip and the platform is then varied continuously or step wise at a rate of Δz per contour segment (FIG. 9C). The end point of the last segment of the contour is optionally and preferably connected to the start point of the contour on the subsequent layer. In various exemplary embodiments of the invention there is no change in the vertical distance during the extrusion of the contour(s) that form the topmost layer of the surrounding wall of the cavity. The resulting manufactured object is illustrated in FIG. 9D.

In some embodiments, the vertical distance between the tip of the extruder and the supporting platform is varied only at a vicinity of a starting point and an ending point of the contour.

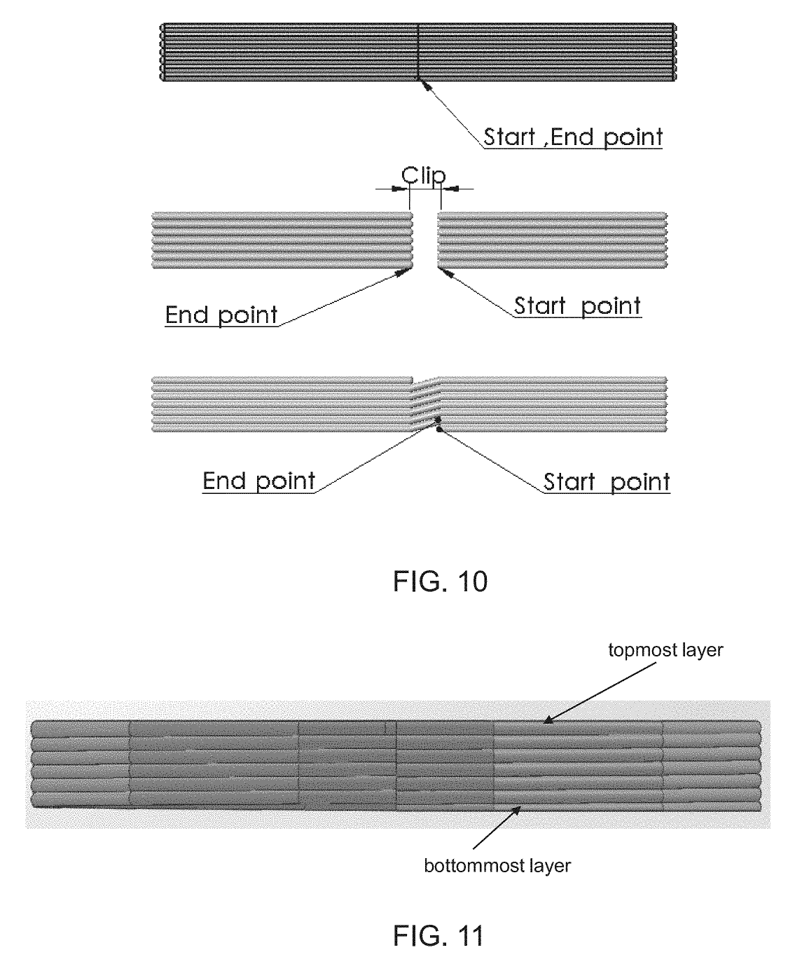

A representative example of such a procedure is schematically illustrated in FIG. 10. For a respective layer, closed contour(s) onto which other contours are to be extruded in a subsequent layer are identified. An example of such a contour is the outermost contour of a layer which is part of a vertical wall. On each identified contour c in the respective layer, a point is selected. There after, a gap is defined in the contour at the selected point. For example, the selected point can be defined as a starting point of the closed contour, and the gap can be defined from that point over a predetermined distance along the contour. The vertical relative movement between the tip and the supporting platform is established at the beginning of the gap (namely when the tip is above the beginning of the gap) and is maintained until the tip is above the end of the gap. Typically, during the vertical relative movement, the vertical distance between the tip and the platform increases by an amount that equals to the height of a layer. In various exemplary embodiments of the invention the contour above contour c is extruded from the point at which the vertical relative movement was ceased, and without ceasing the extrusion. Such extrusion protocol ensures that the end point of contour c merges with the start point of the contour that is extruded directly above contour c.

The length of the gap is preferably predetermined. Typically, the length of the gap is more than the typical height of the layer. In these embodiments, a contour segment having a vertical slope which is less than 45 degrees is formed along the gap.

Representative examples of objects manufactured according to the embodiments described with respect to FIG. 10 are illustrated in FIGS. 5C and 6.

In some embodiments of the present invention the thickness of one or more contours is varied, preferably increased, synchronously with the vertical relative motion during extrusion. These embodiments are particularly useful for the bottommost layer, in cases in which it is desired to manufacture an object having a substantially planar base. In such cases, the lower part of the contour engages the same plane, while the upper part passes through at least two layers of the manufactured object. A representative example of an object manufactured according to these embodiments is illustrated in FIG. 11.

In some embodiments of the present invention, prior to operation 34 (for example, immediately after 31), the method receives, at 38, a starting point for one more contours relative to its respective layer. In these embodiments, the extrusion path 34 of this contour at the respective layer is initiated at the input starting point.

The advantage of letting the operator to decide regarding the starting point is that it allows placing the starting point in a non-random manner. For example, the operator of the extrusion additive manufacturing system can select the starting point at a hidden location over the layer, thereby improving the aesthetic appearance of the manufactured object.

In some embodiments of the present invention the starting points of all contours, other than the contours for which an input starting points have been received, are selected automatically, optionally and preferably by a data processor or a computer. The calculation is preferably based on the input starting point as received at 38 and also based the outline of the three-dimensional object. Generally, the starting points are optionally and preferably selected to follow a line that that is parallel to the outline of the object, but is not-parallel to the layers. The followed line preferably intersects the starting point received as input at 38. For example, when the object or a part thereof has a shape of a cuboid (e.g., a rectangular cuboid) the line that can be followed is a straight line that is perpendicular to the layers and that intersects the starting point received as input. In this example, all the starting points for the contours of the layers that form the cuboid can be set to be equal (relative to the respective layer) to the starting point received at 38. When the object has a shape that does not belong to the cuboid family, the line that is followed is not a straight line and/or is not at a right angle to the layers.

The method ends at 37.

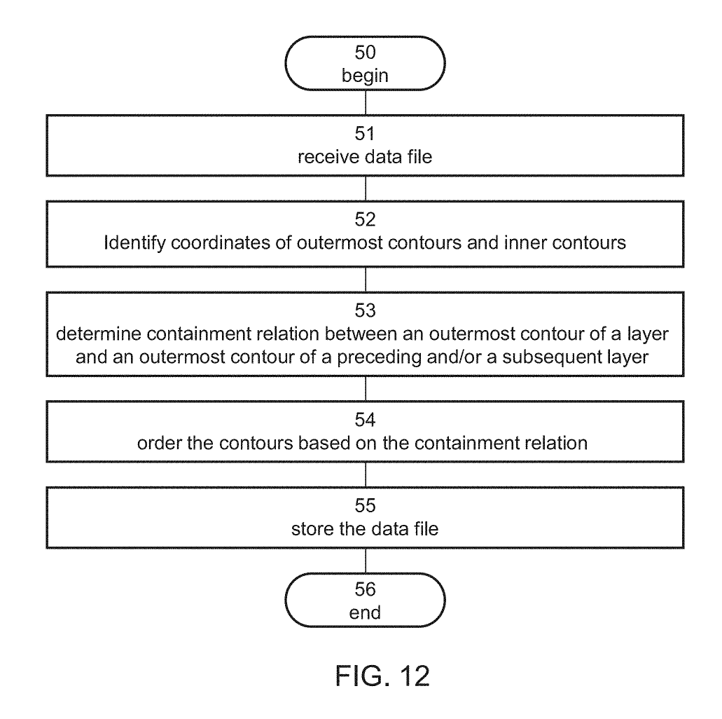

FIG. 12 is a flowchart diagram of a method suitable for processing a data file for extrusion additive manufacturing, according to some embodiments of the present invention. The method can be executed by a data processor (e.g., computer 28, or one or more components thereof) being in communication with a controller (e.g., controller 26) of an extrusion additive manufacturing system (e.g., system 10). The method begins at 50 and continues to 51 at which the data file is received. The data file comprises slice data in the form of three-dimensional contour coordinates which define a plurality of planes corresponding to planar slices of the object, as further detailed hereinabove.

The method optionally and preferably continues to 52 at which coordinates of outermost contours and coordinates of inner contours with respect to outermost contours are identified. Operation 52 is executed separately for each of at least some of the slices in the data file. Preferably, operation 52 is executed separately for each slice in a block of several (e.g., 3 or more) adjacent slices in the data file. More preferably, operation 52 is executed for each slice in the data file. The method optionally and preferably continues to 53 at which the containment relation between an outermost contour of the respective slice and an outermost contour of a preceding slice or a subsequent slice in the data file, is determined.

The method optionally and preferably continues to 54 at which the contours in the respective slice are ordered based on the identification 52 and based on the containment relation determined at 53.

The term “ordering”, when applied to contours in a data file, refers to a sequence of contour extrusion instructions for the controller of the extrusion additive manufacturing system. Specifically, for any given pair of contours C₁ and C₂, the coordinates of contour C₁ in the data file are said to be “before” the coordinates of contour C₂ in the data file, when the controller is instructed to extrude contour C₁ before contour C₂; and the coordinates of contour C₁ in the data file are said to be “after” the coordinates of contour C₂ in the data file, when the controller is instructed to extrude contour C₁ after contour C₂.

Following are several criteria that can be used according to some embodiments of the present invention for ordering the contours in a given slice, referred to as slice sₙ, where n=1, 2, . . . , nₘₐₓ is a positive integer denoting the position of the given slice within the object, with n=1 denoting the bottommost slice, and n=nₘₐₓ denoting the topmost slice.

Several criteria are optionally and preferably considered when sₙ is an intermediate slice (namely it is above at least one slice and below at least one slice).

According to one criterion, when, according to 52 and 53, the outermost contour of the respective slice contains an outermost contour of the subsequent slice sₙ₊₁, then the contours in sₙ are ordered from the outermost contour of sₙ to a contour in sₙ which is below the outermost contour of the subsequent slice sₙ₊₁. According to another criterion, when, according to 52 and 53, coordinates of an inner contour are identified in sₙ and the outermost contour in sₙ contains the outermost contour of the subsequent slice sₙ₊₁, then the contours are ordered from a contour below the outermost contour of sₙ₊₁ to the innermost contour of sₙ.

Several criteria are optionally and preferably considered when sₙ is a non-bottommost slice of the object (namely it is above at least one slice). According to one criterion, when the outermost contour of sₙ contains the outermost contour of the preceding slice sₙ₋₁, then the contours are ordered from a contour above the outermost contour of sₙ₋₁ to the outermost contour of sₙ. According to another criterion, when coordinates of inner contours are identified in sₙ and the outermost contour in sₙ contains the outermost contour of sₙ₋₁, then the contours are ordered from a contour above the outermost contour of sₙ₋₁ to the innermost contour of slice sₙ.

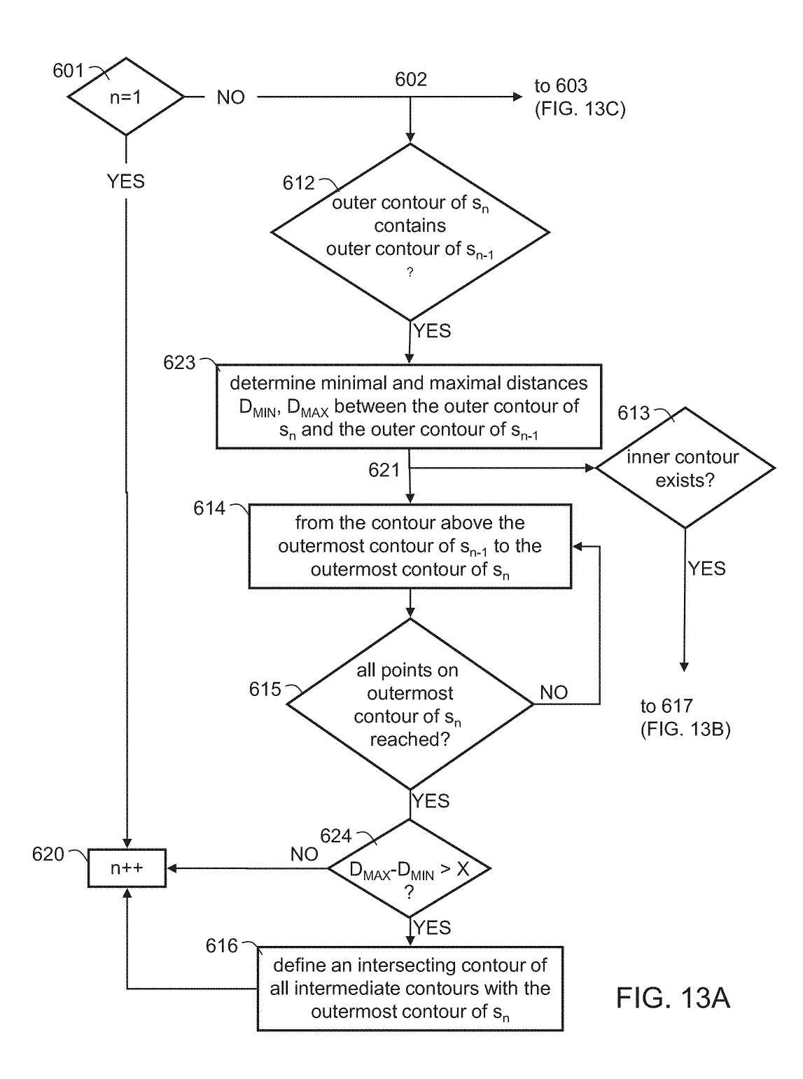

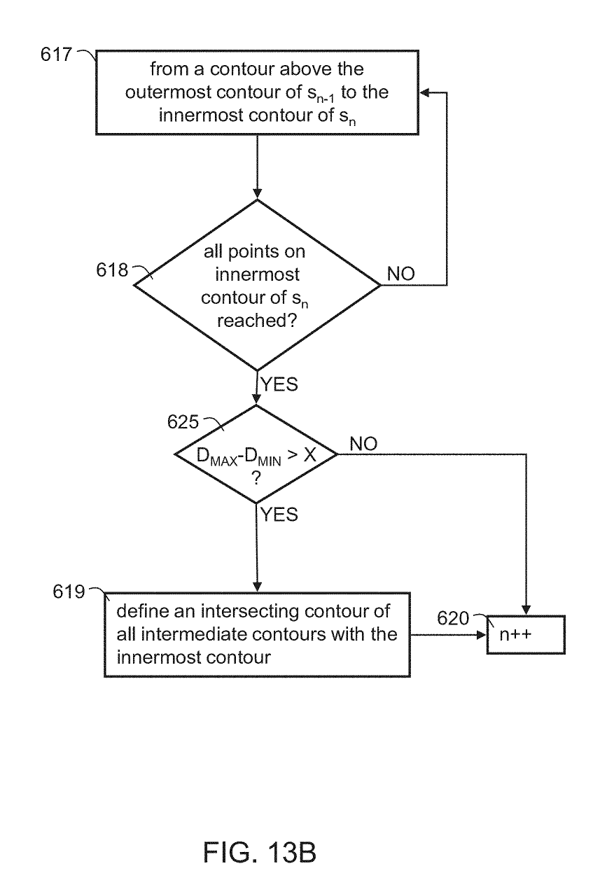

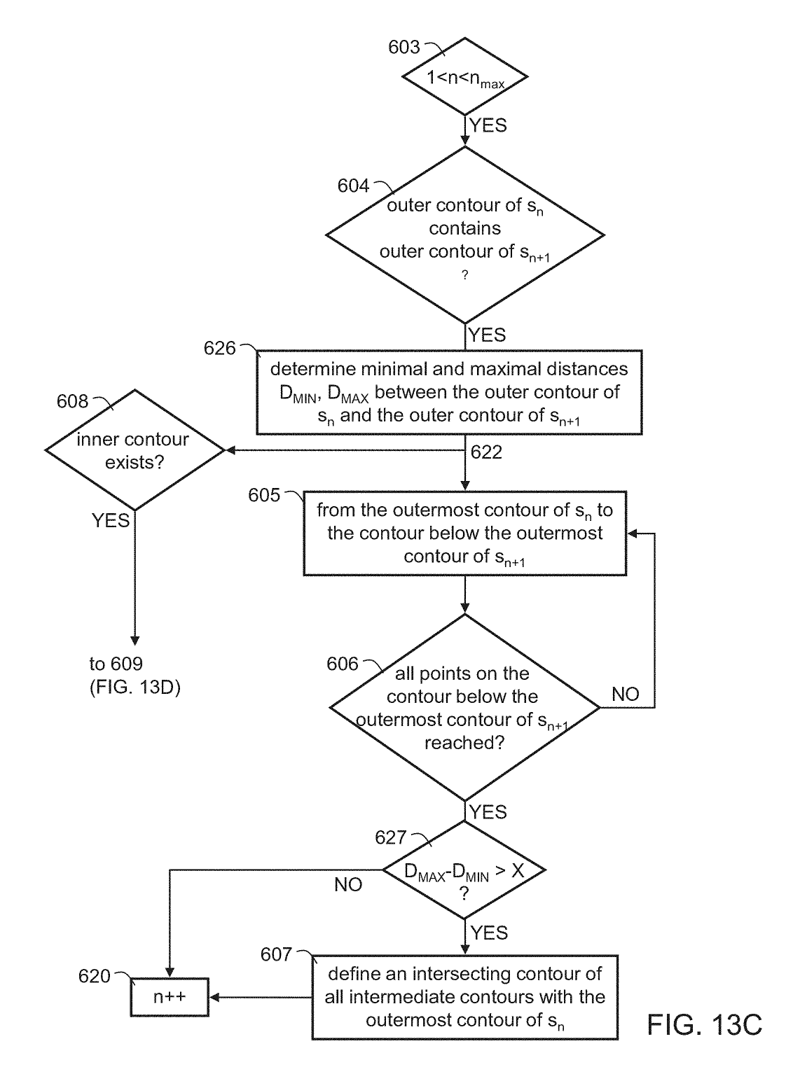

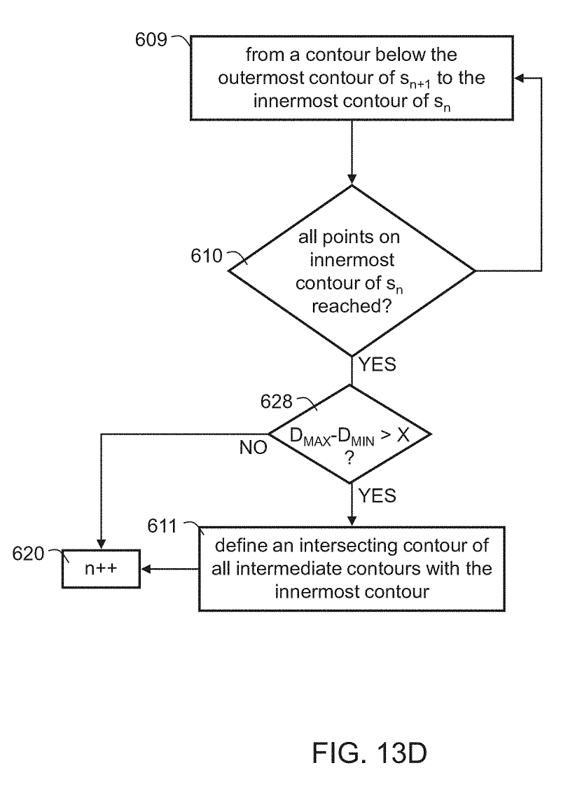

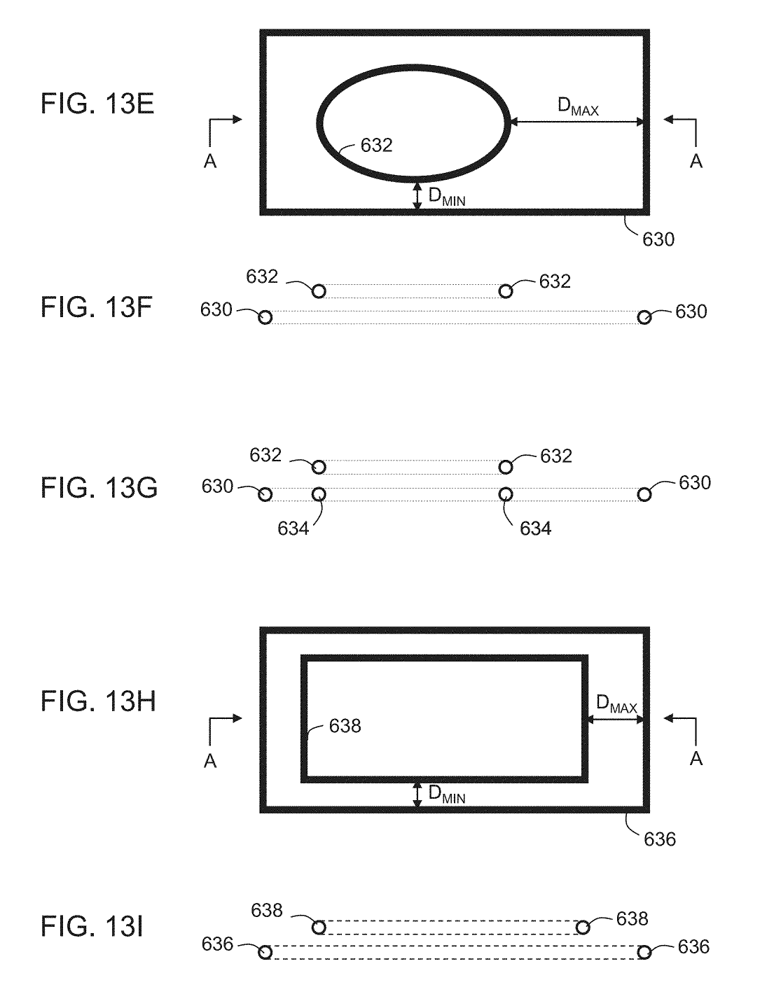

A flowchart diagram, describing in more detail a procedure based on a set of criteria for the ordering of the contours according to some embodiments of the present invention is shown in FIGS. 13A-D.

As shown, in decisions 601 and 603 the procedure determines whether the slice is the bottommost slice (n=1), a non bottommost slice (1<n≦nₘₐₓ) or an intermediate slice (1<n<nₘₐₓ). For the bottommost slice, the procedure preferably does not manipulate the data file, and continues directly to 620 at which n is increased by 1. Otherwise, the procedure continues to fork 602 from which the procedure continues both to decision 612 and decision 603, which can be executed at any order or contemporaneously.

At decision 603, the procedure determines whether or not the slice is an intermediate slice (1<n<nₘₐₓ). If the slice is an intermediate slice, the procedure proceeds to decision 604 at which the procedure determine the lateral containment relation between the outermost contour of slice sₙ, hereinafter contour oₙ, and the outermost contour of slice, hereinafter contour oₙ₊₁.

If the contour oₙ laterally contains contour oₙ₊₁, the procedure optionally continues to 626 at which the procedure quantifies the lateral containment. This is optionally and preferably done by calculating the minimal lateral distance D_{MIN} and the maximal lateral distance D_{MAX} between contours oₙ and oₙ₊₁. From 626 or 604 the procedure moves to fork 622 from which the procedure continues both to decision 608 and process 605, which can be executed at any order or contemporaneously.

The quantification of the containment can be used as a criterion for defining intersecting contours as will now be explained with reference to FIGS. 13E-I.

FIGS. 13E and 13F illustrate two outermost contours 630 and 632 of two sequential slices, where FIG. 13E is a top view and FIG. 13F is a cross-sectional view along the line A---A of FIG. 13E. The outermost contour 632 is laterally contained in the outermost contour 630. In the representative illustration, the slice to which the containing contour 630 belongs precedes the slice to which the contained contour 632 belongs (for example, contour 630 can be the outermost contour oₙ of slice sₙ and contour 632 can be the outermost contour oₙ₊₁ of slice sₙ₊₁), but this need not necessarily be the case.

Also shown, are the minimal D_{MIN} and maximal D_{MAX} distances between contours 632 and 630 (FIG. 13E). The distances D_{MIN} and D_{MAX} are preferably expressed in units of contour thickness. Suppose, for example, that for contours 630 and 632 the difference D_{MAX}−D_{MIN} is larger than a predetermined threshold X. According to some embodiments of the present invention, an intersecting contour 634 is defined within the slice that include the containing contour (the slice sₙ, in the present example), wherein the shape and size of the intersecting contour 634 are the same as those of the contained contour 632. This embodiment is illustrated in FIG. 13G. A typical value for the threshold X, in units of contour thickness, is from about 2 to about 6, or from about 2 to about 5, or from about 2 to about 4, or from about 2 to about 3.

Another situation is illustrated in FIGS. 13H and 13I, which illustrate two outermost contours 636 and 638 of two sequential slices, where FIG. 13H is a top view and FIG. 13I is a cross-sectional view along the line A---A of FIG. 13H. The outermost contour 638 is laterally contained in the outermost contour 636. In the representative illustration, the slice to which the containing contour 636 belongs precedes the slice to which the contained contour 638 belongs (for example, contour 636 can be the outermost contour oₙ of slice sₙ and contour 638 can be the outermost contour oₙ₊₁ of slice sₙ₊₁), but this need not necessarily be the case.

As shown in FIGS. 13E and 13F, the difference between D_{MAX} and D_{MIN} is larger for contours 630 and 632 than for contours 636 and 638. Suppose, for example, that for contours 636 and 638 the difference D_{MAX}−D_{MIN} is not larger than the predetermined threshold X. In this case, no additional intersecting contour is defined in the slice that includes the containing contour 636.

Referring again to FIG. 13C, at 605 the contours are ordered from contour oₙ to the contour below contour oₙ₊₁. Once all the points of the contour in sₙ which is below contour oₙ₊₁ have been reached (decision 606), the procedure optionally and preferably proceeds to decision 627 at which the procedure compares the difference D_{MAX}−D_{MIN} to the threshold X. If the difference is not larger than X, the procedure continues to 620 at which n is increased by 1. Otherwise, the procedure optionally and preferably moves to 607 at which an intersecting contour is defined, and then continues to 620 at which n is increased by 1.

At 608 the procedure determines if there are inner contours in the slice. If there are inner contours in the slice, the procedure proceeds to 609 at which the contours are ordered from the contour in sₙ below contour oₙ₊₁ to contour oₙ. Once all the points of the innermost contour of sₙ have been reached (decision 610), the procedure optionally and preferably proceeds to decision 628 at which the procedure compares the difference D_{MAX}−D_{MIN} to the threshold X. If the difference is not larger than X, the procedure continues to 620 at which n is increased by 1. Otherwise, the procedure optionally and preferably moves to 611 at which an intersecting contour is defined, and then continues to 620 at which n is increased by 1.

At decision 612, the procedure determine the containment relation, within slice sₙ, between contour oₙ and the outermost contour of slice sₙ₋₁, hereinafter oₙ₋₁. If contour oₙ contains contour oₙ₋₁ within slice sₙ, the procedure optionally continues to 623 at which the procedure quantifies the containment. This is optionally and preferably done by calculating the minimal distance D_{MIN} and the maximal distance D_{MAX} between contours oₙ and oₙ₋₁. From 623 or 612 the procedure moves to fork 621 from which the procedure continues both to decision 613 and process 614, which can be executed at any order or contemporaneously.

At 614, the contours are ordered from the contour above contour oₙ₋₁ to contour oₙ. Once all the points of contour oₙ have been reached (decision 615), the procedure optionally and preferably proceeds to decision 624 at which the procedure compares the difference D_{MAX}−D_{MIN} to the threshold X. If the difference is not larger than X, the procedure continues to 620 at which n is increased by 1. Otherwise, the procedure optionally and preferably moves to 616 at which an intersecting contour is defined, and then continues to 620 at which n is increased by 1.

At 613, the procedure determine whether or not there are inner contours in the slice sₙ. If there are inner contours in the slice, the procedure proceeds to 617 at which the contours are ordered from the contour above the contour oₙ₋₁ to the innermost contour of sₙ. Once all the points of the innermost contour of sₙ have been reached (decision 618), the procedure optionally and preferably proceeds to decision 625 at which the procedure compares the difference D_{MAX}−D_{MIN} to the threshold X. If the difference is not larger than X, the procedure continues to 620 at which n is increased by 1. Otherwise, the procedure optionally and preferably moves to 619 at which an intersecting contour is defined, and then continues to 620 at which n is increased by 1.

The procedure continues until all the slices have been visited.

The data file is then updated with the ordered contours and the method (FIG. 12) continues to 55 at which the processed data file with the ordered contours is stored in a medium readable by the controller of the extrusion additive manufacturing system.

The method ends at 56.

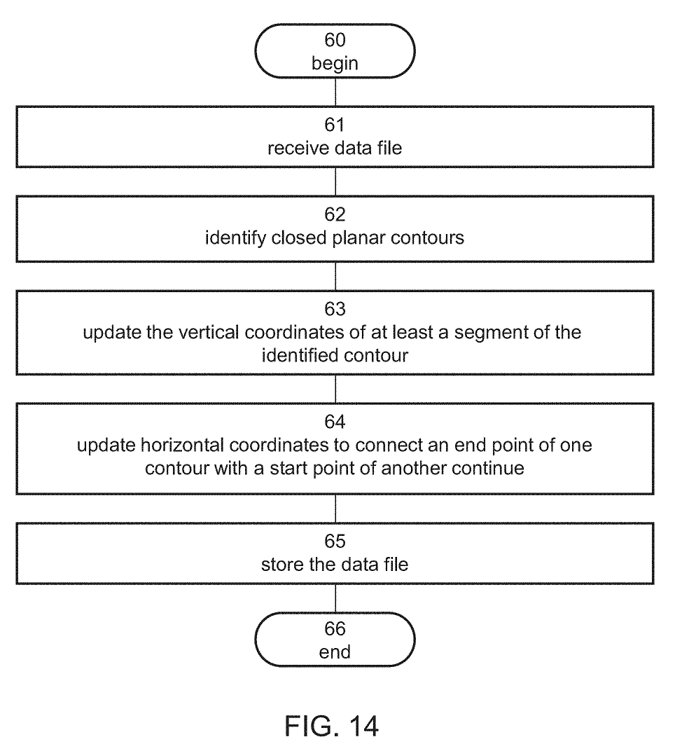

FIG. 14 is a flowchart diagram of another method suitable for processing a data file for extrusion additive manufacturing, according to some embodiments of the present invention. The method can be executed by a data processor (e.g., computer 28, or one or more components thereof) being in communication with a controller (e.g., controller 26) of an extrusion additive manufacturing system (e.g., system 10).

The method begins at 60 and continues to 61 at which the data file is received.

The data file comprises slice data in the form of three-dimensional contour coordinates which define a plurality of planes corresponding to planar slices of the object, as further detailed hereinabove. The method proceeds to 62 at which closed planar contours are identified in the data. The method proceeds to 63 at which, for each of at least some of the closed contours, the vertical coordinates of at least a segment of the respective contour is updated, such that, following the update, the segment is tilted at an angle relative to a plane engaged by the contour prior to the update. Representative examples of such a procedure are described hereinabove with reference to FIGS. 9 and 10.

In some embodiments of the invention, the method proceeds to 64 at which the horizontal coordinates of one or more contours engaging a plane are updated, so as to connect an ending point of contour with a starting point of another contour engaging plane, thereby providing a combined contour. These embodiments are particularly useful when it is desired to extrude one or more segments of a contour along a spiral path.

Once the coordinates of the contours are updated the method continues to 65 at which the processed data file with the updated coordinates is stored in a medium readable by the controller of the extrusion additive manufacturing system.

The method ends at 66.

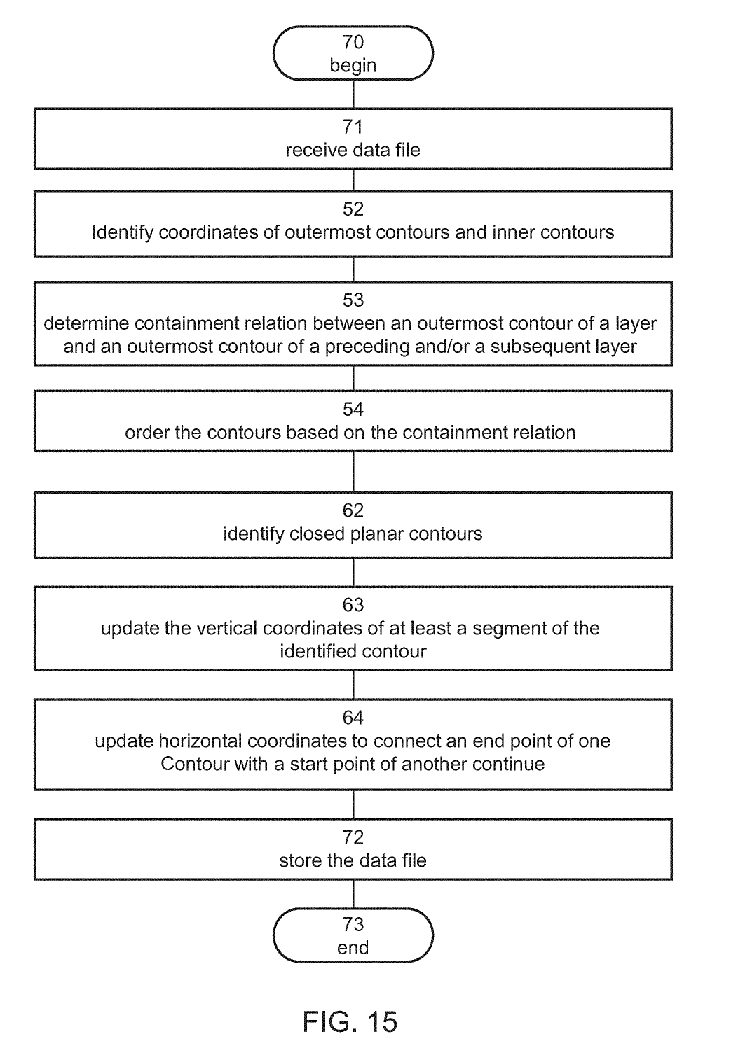

Method 60 can be executed independently, or it can be combined with method 50 above. For example, before, during or after the processing of the contours of a particular layer according to method 50, the contours of the layer can additionally be processed according to method 60. Such two-fold processing can optionally and preferably be executed for each layer of the data file. A representative flowchart diagram of a method that combines methods 50 and method 60 is illustrated in FIG. 15. This method can be executed by a data processor (e.g., computer 28, or one or more components thereof) being in communication with a controller (e.g., controller 26) of an extrusion additive manufacturing system (e.g., system 10). This method begins at 70 and continues to 71 at which the data file is received, as further detailed hereinabove.

The method optionally and preferably continues to 52 at which coordinates of outermost contours and coordinates of inner contours with respect to outermost contours are identified, as further detailed hereinabove. The method optionally and preferably continues to 53 at which the containment relation between an outermost contour of the respective slice and an outermost contour of a preceding slice or a subsequent slice in the data file is determined, as further detailed hereinabove. The method optionally and preferably continues to 54 at which the contours in the respective slice are ordered based on the identification and containment relation, as further detailed hereinabove. The method proceeds to 62 at which closed planar contours are identified in the data, and to 63 at which, for each of at least some of the closed contours, the vertical coordinates of at least a segment of the respective contour is updated, as further detailed hereinabove. In some embodiments of the invention, the method proceeds to 64 at which the horizontal coordinates of one or more contours engaging a plane are updated, as further detailed hereinabove.

Once the contours are ordered, and the coordinates of the contours are updated the method continues to 72 at which the processed data file with the ordered contours and updated coordinates is stored in a medium readable by the controller of the extrusion additive manufacturing system.

The method ends at 73.

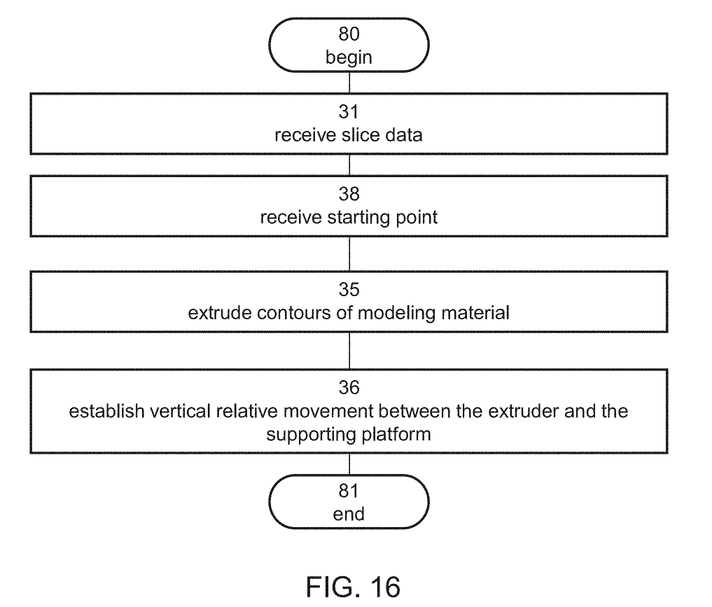

FIG. 16 is a flowchart diagram of an additional method suitable for additive manufacturing of a three-dimensional object, according to some embodiments of the present invention. The method can be executed by system 10.

The method begins at 80 and continues to 31 at which slice data are received, as further detailed hereinabove. Optionally, the method continues to 38 at which the method receives a starting point for one more contours relative to its respective layer, as further detailed hereinabove. The method continues to 35 at which contours of a modeling material are extruded to form a plurality of layers corresponding to the slice data of the object, as further detailed hereinabove. Optionally, the method continues to 36 at which at which a vertical relative movement between the tip of the extruder and the supporting platform is established, while the modeling material is extruded, as further detailed hereinabove.

Any of optional operations 38 and 36 of method 80 can be executed independently. Thus, in some embodiments of the present invention operations 35 and 36 are executed and operation 38 is not executed, in some embodiments of the present invention operations 35 and 38 are executed and operation 36 is not executed, and in some embodiments of the present invention operations 35, 38 and 36 are executed.

The method ends at 81.

It is expected that during the life of a patent maturing from this application many relevant extrusion additive manufacturing will be developed and the scope of the term extrusion additive manufacturing system is intended to include all such new technologies a priori.

As used herein the term “about” refers to ±10%.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of additive manufacturing of a three-dimensional object, the method comprising:
extruding contours of a modeling material to form a plurality of layers corresponding to slice data of the object;
wherein at least one of said contours is extruded generally horizontally above a three-dimensional region which is devoid of any solid support.

2. The method according to claim 1, wherein a largest horizontal dimension of said three-dimensional region is larger than a characteristic diameter of said contours by a factor of at least 5.

3. The method according to claim 1, wherein a largest horizontal dimension of said three-dimensional region is larger than a characteristic diameter of said contours by a factor of at least 10.

4. The method according to claim 1, wherein said three-dimensional region is internal to said object.

5. The method according to claim 1, wherein said three-dimensional region is external to said object.

6-23. (canceled)

24. The method according to claim 1, wherein the object has a curvature along a vertical direction, and wherein for at least a portion of said layers, a number of contours or contour segments forming each layer is varied as a function of a slope of the curvature along said vertical direction.

25-33. (canceled)

34. A system for additive manufacturing of a three-dimensional object, the system comprising:
a supporting platform;
a modeling material extruder; and
a controller operatively associated with a computer and being configured to receive slide data of the object from said computer and to control said extruder to extrude contours of a modeling material thereby to form on said supporting platform a plurality of layers corresponding to said slice data, wherein at least one of said contours is extruded generally horizontally above a three-dimensional region which is devoid of any solid support.

35. The system according to claim 34, wherein said three-dimensional region is internal to said object.

36. The system according to claim 34, wherein said three-dimensional region is external to said object.

37. The system according to claim 34, wherein said at least one contour is supported by at least two vertical walls bordering said three-dimensional region.

38. The system according to claim 34, wherein said at least one contour is supported by only one wall bordering said three-dimensional region.

39. The system according to claim 34, wherein said at least one contour forms a continuous layer which completely covers said three-dimensional region.

40. (canceled)

41. The system according to claim 34, wherein at least a segment of said at least contour is extruded outwardly from a vertical wall of the object, and above said three-dimensional region, in a manner that said segment is not tangential to any other previously extruded segment.

42. (canceled)

43. The system according to claim 34, wherein said at least one contour forms a layer which only partially covers said three-dimensional region.

44. (canceled)

45. The system according to claim 43, wherein said layer is continuous.

46. (canceled)

47. The system according to claim 43, wherein said layer is discontinuous.

48. (canceled)

49. The system according to claim 43, wherein said layer has an opening above said three-dimensional region.

50. (canceled)

51. The system according to claim 43, wherein at least a segment of said at least one contour is extruded horizontally along a spiral path.

52. (canceled)

53. The system according to claim 34, further comprising said computer.

54. (canceled)

55. The system according to claim 53, wherein said computer is configured to determine, for at least one layer, a containment relation between an outermost contour of said layer and an outermost contour of a preceding or a subsequent layer, and to select an extrusion path for said at least one layer based on said containment relation.

56. (canceled)

57. The system according to claim 55, wherein said at least one layer has an opening above said three-dimensional region, and wherein said computer is configured to determine a locus of intersection between a periphery of said opening and said extrusion path, and to update said extrusion path based on said locus of intersection.

58. (canceled)

59. The system according to claim 34, further comprising a user interface configured for receiving as a user input a starting point for at least one contour relative to a respective at least one layer, wherein said extrusion of said at least one contour at said respective at least one layer is initiated at said starting point.

60. (canceled)

61. The system according to claim 59, wherein said computer is configured to automatically select starting points for all contours other than said at least one contour, based on an outline of said three-dimensional object.

62. (canceled)

63. A method of additive manufacturing of a three-dimensional object, the method comprising:
receiving as a user input a starting point for at least one contour relative to a respective at least one layer; and
extruding contours of a modeling material to form a plurality of layers corresponding to slice data of the object, wherein said extrusion of said at least one contour at said respective at least one layer is initiated at said starting point.

64. The method according to claim 63, further comprising automatically selecting starting points for all contours other than said at least one contour, based on an outline of said three-dimensional object and based on said input starting point.

65. A system for additive manufacturing of a three-dimensional object, the system comprising:
a supporting platform;
a modeling material extruder;
a controller operatively associated with a computer; and
a user interface configured for receiving as a user input a starting point for at least one contour relative to a respective at least one layer;
wherein said controller is configured to receive slide data of the object from said computer and to control said extruder to extrude contours of a modeling material thereby to form on said supporting platform a plurality of layers corresponding to said slice data, wherein said extrusion of said at least one contour at said respective at least one layer is initiated at said starting point.

66. The system according to claim 65, wherein said computer is configured to automatically select starting points for all contours other than said at least one contour, based on an outline of said three-dimensional object.

67-75. (canceled)
